(19) United States
(12) Patent Application Publication
(10) Pub. No.: US 2008/0075173 A1
(43) Pub. Date: Mar. 27, 2008

(54) Systems and Methods for Context Adaptive Video Data Preparation

(75) Inventors: Anurag Mithalal Jain, Bangalore (IN); Sunand Mittal, Ghaziabad (IN); Akhilesh Persha, Hyderabad (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/534,437

(22) Filed: Sep. 22, 2006

(51) Int. Cl. H04N 11/02; H04N 7/12

(52) U.S. Cl. 375/240.25; 375/240.26

(57) ABSTRACT

Systems and methods for encoding and decoding video image data are included. In some cases, the methods are tailored for highly parallel operation on a very long instruction word processor. Various of the embodiments may be implemented in relation to H.264/MPEG-4 AVC video compression standard.

### BACKGROUND OF THE INVENTION

The present invention is generally related to systems and methods for encoding and decoding information. More particularly, the present invention is related to systems and methods for encoding and/or decoding video information.

The ITU-T (International Telecommunications Union Telecommunications Committee) and MPEG (International Standards Organization Moving Picture Experts Group) have developed video coding standards known as H.264/MPEG-4 AVC that provides for increased video coding efficiency. Some estimate that the standards offer a twofold improvement in compression ratio and improved quality when compared with preceding standards. “Video Compression's Quantum Leap”, Electronic Design News, Dec. 11, 2003, pp. 73-78. FIG. 1 shows a general block diagram of a system 100 capable of performing video encoding and decoding in accordance with the standards.

In particular, system 100 includes an encoder 102 and a decoder 101. Encoder 102 receives uncompressed video 180 and encodes the video to make compressed video 185. In contrast, decoder 101 accepts compressed video 185 and decodes it to make uncompressed video 181. Encoder 102 includes an estimation block 110, a transform block 120, a quantization block 130, an entropy encoding block 140, an inverse quantization block 150, an inverse transform block 160, a loop filter 170, and a differential block 190. In operation, encoder 102 segments a frame of uncompressed video 180 into blocks of pixels or macro blocks. These macro blocks are generally 16×16 partitions of pixels and are presented to estimation block 110 where motion estimation is performed to determine both spatial and temporal redundancy between frames. Next, an algorithm is performed by transform block 120 to produce an expression of the motion estimated data in the lowest number of coefficients possible. The coefficients representing the motion compensated data are then quantized by quantization block 130. Entropy encoding block 140 then removes statistical redundancy to remove the average number of bits necessary to represent uncompressed video 180 as compressed video 185.

The entropy encoding maps symbols representing motion vectors, quantized coefficients, and macro block headers into actual bits. To do so, entropy encoding block 140 serializes the quantized data into a one dimensional array from a two-dimensional array by traversing the two-dimensional array in a zigzag order. The resulting one dimensional array includes the DC coefficient in the first array position, with the following AC coefficients being placed in a low-frequency to high-frequency order. The higher frequency coefficients tend to be zero due to the quantization process making it advantageous to use run-length encoding to group trailing groups of zeros. The H.264 standard also introduced CAVLC (Context-Adaptive Variable-Length Coding) and its counterpart CAVLD (Context-Adaptive Variable-Length Decoding) which together offer a unique entropy encoding approach relying on tables that are adaptively selected based on the probability of occurrences of different symbols within a particular run-length. Unfortunately, the sequential nature and incidence of conditional branching of a typical algorithm used to implement CAVLD makes it unsuitable for implementation on VLIW (Very Long Instruction Word) processors.

Decoder 101 operates to reverse the functions of encoder 102, with an entropy decoding block 111 that operates to decode the entropy encoded block 140. In addition, a motion compensation block 121, an inverse quantization block 151 and an inverse transform block 161 operate to reverse the operations performed by the corresponding blocks in encoder 102. The outputs of motion compensation block 121 and inverse transform block 161 are summed using a summation block 191. The output of summation block 191 is provided to a loop filter 171, which in turn provides uncompressed video 181.

Hence, for at least the aforementioned reasons, there exists a need in the art for advanced systems and methods for performing encoding and/or decoding.

### BRIEF SUMMARY OF THE INVENTION

The present invention is generally related to systems and methods for encoding and decoding information. More particularly, the present invention is related to systems and methods for encoding and/or decoding video information.

Some embodiments of the present invention provide systems and methods for decoding video image data. Such methods include receiving an encoded video image data set, and based on the video image data set, determining a run before value and a non-zero coefficient value. The non-zero coefficient value is stored to a memory register, and a position of the non-zero coefficient value is determined based at least in part on the run before value. In addition, an inverse quantization is performed on the non-zero coefficient value prior to removing the non-zero coefficient value from the memory register. In some cases, the method is utilized to eliminate inverse quantization performed on one or more zero coefficients. In various cases, the inverse quantization is performed immediately subsequent to determining the position of the non-zero coefficient value, and/or prior to determining a subsequent non-zero coefficient value.

Systems in accordance with the aforementioned embodiments may include a processor based computer associated with a computer readable medium, where the computer readable medium includes instructions executable by the processor. In some cases, the processor is a very long instruction word processor and the instructions executable by the processor are tailored for substantially parallel operations. In one particular case, the processor is a digital signal processor. The instructions are executable by the processor to receive an encoded video image data set, and based on the video image data set, to determine a run before value and a non-zero coefficient value. The instructions are further executable by the processor to store the non-zero coefficient value to a memory register, and to determine a position of the non-zero coefficient value based at least in part on the run before value. In addition, the instructions are executable by the processor to perform an inverse quantization on the non-zero coefficient value prior to removing the non-zero coefficient value from the memory register.

Other embodiments of the present invention provide systems and methods for decoding or otherwise manipulating video data. Such methods include providing a look up table memory that is organized as a plurality of words. Each of the plurality of words is accessible via a single access to the look up table memory. A particular word of the plurality of words includes at least a two decoded run before values (in some cases, one or more of the values may be invalid).

Systems in accordance with the aforementioned embodiments may include a processor based computer associated with a computer readable medium, where the computer readable medium includes instructions executable by the processor. In some cases, the processor is a very long instruction word processor and the instructions executable by the processor are tailored for substantially parallel operations. In one particular case, the processor is a digital signal processor. The instructions are executable by the processor to access a look up table memory that is organized as a plurality of words. Each of the plurality of words is accessible via a single access to the look up table memory. A particular word of the plurality of words includes at least a two decoded run before values. Such systems may be capable of performing multiple run before decodes in a single memory access.

Yet other embodiments of the present invention provide systems and methods for decoding an encoded video data image set. Such methods include assigning a neighbor block availability word to a block within the video image data, and loading an array of neighbor block information associated with the block within the encoded video image data set. An N_{C} value associated with the block within the encoded video image data set is calculated using a parallel tailored equation to perform the calculation. The variables of the parallel tailored equation include a derivative of the array of neighbor block information and a derivative of the neighbor block availability word. In some cases, the methods further include forming the neighbor block availability word that is formed based on a location of a block within the encoded video image data set. In particular instances, the encoded video image data set is formed by groups of 16×16 pixels of luma data and groups of two blocks of 8×8 pixels representing chroma data. In such instances, the neighbor block availability word may be one of the following: 0xFFFFFF, 0xAAFAFA, 0xCCFFCC, or 0x88FAC8.

Systems in accordance with the aforementioned embodiments may include a processor based computer associated with a computer readable medium, where the computer readable medium includes instructions executable by the processor. In some cases, the processor is a very long instruction word processor and the instructions executable by the processor are tailored for substantially parallel operations. In one particular case, the processor is a digital signal processor. The instructions are executable by the processor to assign a neighbor block availability word to a block within the encoded video image data set, and to load an array of neighbor block information associated with the block within the encoded video image data set. The instructions are further executable by the processor to access a parallel tailored equation, and to calculate an N_{C} value associated with the block within the encoded video image data set. The variable of the single unified include a derivative of the array of neighbor block information and a derivative of the neighbor block availability word.

Yet further embodiments of the present invention provide systems and methods for reducing computational bandwidth associated with decoding an encoded video image data set. Such methods include accessing a coded block pattern that includes a plurality of indicators each representing N blocks. N is a number greater than one, and the indicators identify an availability of non-zero coefficients. The methods further include expanding the coded block pattern to form a coded sub-block pattern. Expanding the coded block pattern includes replicating each indicator of the coded block pattern N times such that each block is represented in the coded sub block pattern by one indicator.

In some cases, the methods further include decoding a block that is associated with an indicator in the coded sub-block pattern. In some situations, the indicator indicates that at least one non-zero coefficient is available from the block when it is actually associated with a block that does not include any non-zero coefficients. In such situations, the indicator is modified to reflect the absence of non-zero coefficients. In such cases, an inverse quantization may be performed. Such an inverse quantization may include accessing the indicator, and based at least in part on the indicator, proceeding with an inverse quantization for the block. Where the indicator indicate the absence of any non-zero coefficients, it may be used to preclude inverse quantization for the associated block.

This summary provides only a general outline of some embodiments according to the present invention. Many other entities, features, advantages and other embodiments of the present invention will become more fully apparent from the following detailed description, the appended claims and the accompanying drawings.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 shows a generic system diagram of a video data encoding system known in the art;

FIG. 2 shows a generic method for video encoding as is known in the art;

FIG. 3 shows a group of three macro blocks that may be manipulated in accordance with one or more embodiments of the present invention;

FIGS. 4a-4b provide a flow diagram 400 showing a method in accordance with some embodiments of the present invention for calculating N_{C};

FIG. 5 is an arrangement showing the relative position of blocks within a partition in accordance with some embodiments of the present invention;

FIG. 6 depicts four alignments that are associated with the four possible twenty-four bit words used to represent available block information in accordance with various embodiments of the present invention;

FIG. 7 is a flow diagram that shows an exemplary calculation of N_{C} utilizing a bit pattern approach in accordance with one or more embodiments of the present invention; and

FIG. 8 is a block diagram showing a memory arrangement that may be utilized to extract multiple run before values in a single memory access in accordance with one or more embodiments of the present invention.

### DETAILED DESCRIPTION OF THE INVENTION

The present invention is generally related to systems and methods for encoding and decoding information. More particularly, the present invention is related to systems and methods for encoding and/or decoding video information.

In general, the context adaptive techniques offered by, for example, the H.264 specification are designed to take advantage of several characteristics of quantized blocks. In general, a ‘block’ is 4×4 partition of pixels, which is a part of macro block (which is a 16×16 partition of pixels). Additional information about CAVLC and CAVLD is included in the H.264 Specification available from ITU-T. In particular, CAVLC uses run-level coding to compactly represent strings of zeros which frequently occur in the quantized blocks. In addition, the highest non-zero coefficients in a quantized block are often sequences of +/−1. CAVLC signals the number of +/−1 coefficients in a compact way. These are often referred to as “trailing ones” or “T1s”, and are coded separately in single bits with a ‘0’ representing a +1 and a ‘1’ representing a −1. Also, there is often a substantial amount of correlation among neighboring blocks in terms of the number of non-zero coefficients. CAVLC exploits this characteristic by taking the neighboring blocks' non-zero coefficients as predictors to code the current block's total number of non-zero coefficients. This total number of non-zero-coefficients is encoded using a selected look-up table, with the selection of look-up table depending upon the number of non-zero coefficients in neighboring blocks. As will be appreciated by one of ordinary skill in the art, CAVLD performs the reverse of the CAVLC processes to reconstruct the compressed data stream created using CAVLC.

Some embodiments of the present invention provide advanced approaches for performing CAVLC and/or CAVLD that may be in some cases advantageous when implemented on a VLIW processor. In some cases, the embodiments utilize one or more processes either separate or in combination including table look-ups, formulas, and unique bit-pattern arrangements for availability of neighbors along with the right composition of different software pipelined loops to provide an efficient processing platform. The aforementioned processes may be utilized in relation to segregating residual block data provided during data encoding into different symbols including, Coeff_Token (indicating total number of non-zero coefficients and number of trailing ones), levels and/or run before values.

Some embodiments of the present invention provide systems and methods for decoding video image data. As used herein, the phrase “video image data” is used in its broadest sense to mean any series or group of two or more related images. Thus, video image data may be, but is in no way limited to, a video that includes multiple frames of image data. Based on the disclosure provided herein, one of ordinary skill in the art will recognize a number of types of video image data that may be accessed and/or manipulated in accordance with one or more embodiments of the present invention. Such methods may include receiving an encoded video image data set. As used herein, the phrase “encoded video image data set” is used in its broadest sense to mean any portion of video image data that has been modified from one form to another form. Thus, an encoded video image data set may be, but is not limited to, H.264/MPEG-4 AVC encoded data. The methods further include determining a run before value and a non-zero coefficient value based on the video image data set. As used herein, a “run before value” is any indicator that suggests the number of zero values proceeding or preceding a non-zero value. Thus, as just one example, where a stream of information includes four zeros followed by one non-zero, the run before value may be four. In the method, the non-zero coefficient value is stored to a memory register, and a position of the non-zero coefficient value is determined based at least in part on the run before value. In addition, an inverse quantization is performed on the non-zero coefficient value prior to removing the non-zero coefficient value from the memory register. Such an inverse quantization may be any calculation or mathematical procedure as is currently performed in relation to decoding encoded video image data.

Various systems in accordance with the aforementioned embodiments may include a processor based computer associated with a computer readable medium, where the computer readable medium includes instructions executable by the processor. As used herein, the term “processor” is used in its broadest sense to mean any system or device capable of executing instructions. Thus, as just one example, the processor may be what is generally referred to as a microprocessor, a microcontroller, or a digital signal processor. In some cases, the processor is a substantially parallel device such as a very long instruction word device as are known in the art. In some cases, the instructions are software, firmware and/or machine code that are either directly executable by the processor, or that may be compiled or otherwise transformed for execution by the processor.

Other embodiments of the present invention provide systems and methods for manipulating video data. Such methods include providing a look up table memory that is organized as a plurality of words. Such a memory may be implemented using any computer readable media including, but not limited to, a hard disk drive, a random access memory, an electrically erasable read only memory, a magnetic storage media, an optical storage media, combinations thereof, and/or the like. Each of the plurality of words is accessible via a single access to the look up table memory. A particular word of the plurality of words includes at least a two decoded run before values. In some cases, the methods further include receiving an encoded video image data set, and extracting an encoded run before value from the encoded video image data set. As used herein, the phrase “encoded run before value” is a run before value that has in some way be modified, and may be decoded to retrieve the original value.

Yet other embodiments of the present invention provide systems and methods for decoding an encoded video data image set. Such methods include assigning a neighbor block availability word to a block within the encoded video image data set, and loading an array of neighbor block information associated with the block within the encoded video image data set. As used herein, the phrase “neighbor block availability word” is used in its broadest sense to mean any information set that is indicative of whether or not a particular block is surrounded by other available blocks. An N_{C} value associated with the block within the encoded video image data set is calculated using a parallel tailored equation to perform the calculation. As used herein, an “N_{C} value” represents the index used to retrieve the Coeff_Token symbol from a look-up table. Also, as used herein, the term “Coeff_Token” denotes a data set that contains the information regarding number of non-zero coefficients and number of trailing ones of a particular block of data. Further, as used herein, the phrase “parallel tailored equation” is used in its broadest sense to mean any equation and/or calculation process that is executable with reduced data dependency.

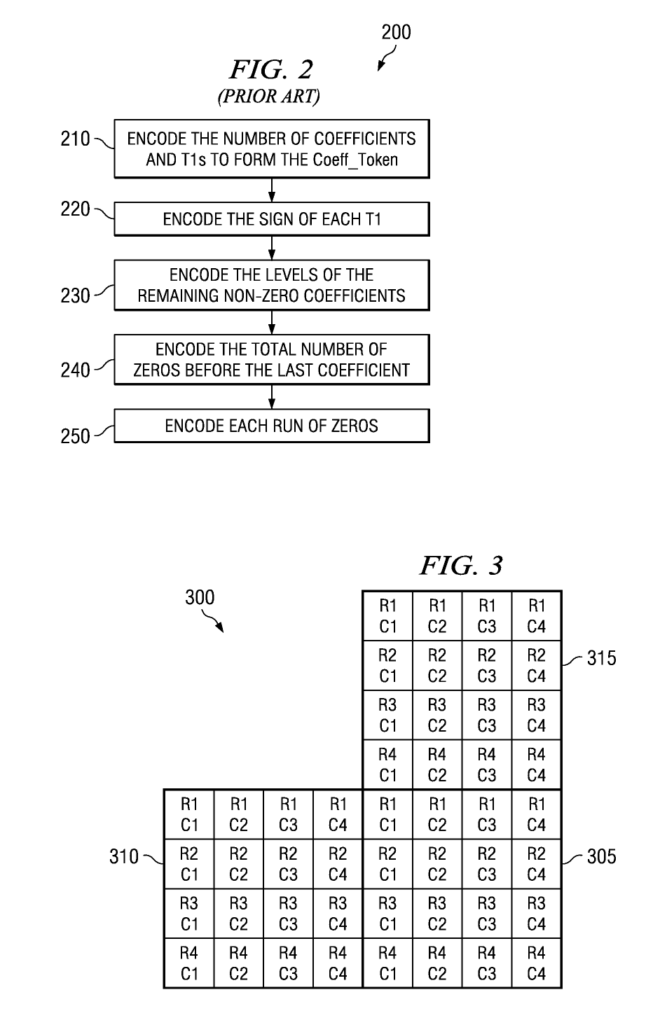

Discussion of the inventions is presented in relation to a flow diagram of FIG. 2 that provides a general outline of the data encoding process. At particular steps of the encoding process, further embellishment describes details of encoding and/or decoding processes that may be used in combination or in place of the steps discussed in relation to FIG. 2, and in accordance with one or more embodiments of the present invention. Such discussion is included coincident with the corresponding block of FIG. 2. Thus, FIG. 2 provides a general framework into which details of the invention are added and discussed. At this juncture, it should be noted that while detail of the inventions are discussed in relation to decoder applications, it is possible to reverse the one or more of the processes for use in encoder applications.

FIG. 2 shows a high level flow diagram 200 of one approach to CAVLC coding in accordance with the H.264 specification. Following flow diagram 200, the Coeff_Token is formed (block 210). The Coeff_Token indicates the total number of non-zero coefficients, and the number of T1s (block 210). The total number of non-zero coefficients can be anything from zero to the total number of elements in a block. Thus, for example, where the pixel block is a 4×4 partition the total number of non-zero coefficients can range from zero (i.e., sixteen zero coefficients) to sixteen (i.e., no zero coefficients). The number of T1s can be anything from zero to three. In the case where there are more than three T1s, only the last three are treated as T1s with the preceding being coded like other non-zero coefficients.

There are four choices of look-up table to use for encoding Coeff_Token that are specified in the H.264 standard. The choice of table depends on a variable N_{C}. N_{C} is derived from number of non-zero coefficients in upper (N_{T}) and left-hand (N_{L}) previously coded blocks. Thus, one of the first tasks to be performed is to determine the availability of the neighboring blocks. In some cases, an available neighboring block will belong to the same macro block, while in other cases, it will belong to a different macro block. FIG. 3 shows a group 300 of three macro blocks 305, 310, 315 of image data, with the current macro block 305 under analysis and surrounded by left-hand macro block 310 and upper macro block 315 on the top. As arranged, the three macro blocks are suited for discussing the four possible scenarios of availability of neighboring blocks: (1) both N_{L} and N_{T} blocks are outside macro block 305 (e.g., R1,C1 of macro block 305 with N_{T} available from macro block 315 and N_{L} available from macro block 310), (2) N_{L} is outside and N_{T} is within macro block 305 (e.g., R2-4,C1 of macro block 305 with N_{T} available from macro block 305 and N_{L} available from macro block 310), (3) N_{T} is outside and N_{L} is within macro block 305 (e.g., R1,C2-4 of macro block 305 with N_{T} available from macro block 315 and N_{L} available from macro block 305), and (4) both N_{L} and N_{T} blocks are within macro block 305 (R-4,C2-4 of macro block 305 with N_{T} available from macro block 305 and N_{L} available from macro block 305).

When decoding the Coeff_Token, the value of N_{C} is derived from the neighboring blocks' non-zero coefficients (N_{T} and N_{L}). N_{C} is used to determine the table index required for decoding Coeff_Token symbol of the current block. N_{C} is calculated based on the average of available N_{T} and N_{L} otherwise it is simply assigned a value of either N_{T} or N_{L} that is available. If neither N_{T} nor N_{L} are available, N_{C} is assigned a default value of zero. The following equations describe the aforementioned conditions:

N_{C}=(N_{T}+N_{L}+1)/2, where both N_{T} and N_{L} are available (which may be implemented as

(N_{T}+N_{L}+1)>>1 where an integer operation is desired);

N_{C}=N_{T}, where only N_{T} is available;

N_{C}=N_{L}, where only N_{L} is available; and

N_{C}=0, where neither N_{T} nor N_{L} are available.

Turning to FIG. 5, an arrangement 500 showing the relative position of blocks within a 4×4 partition of pixels in relation to one another is shown. A group of 4×4 luma data 510 is shown along with the corresponding 2×2 groups 530, 550 of Cb and Cr data. Each group includes a respective group of blocks 516, 536, 556. Each of the blocks within groups 516, 536, 556 is marked with a number from one to twenty-four indicating the order in which the respective block will be processed. Further, each group includes respective left row numbering (i.e., L1-L8) 512, 532, 552, and respective top column numbering (i.e., T1-T8) 514, 534, 554. L1-L8 are the left predictors and T1-T8 are the top predictors for calculating N_{C} for the current block.

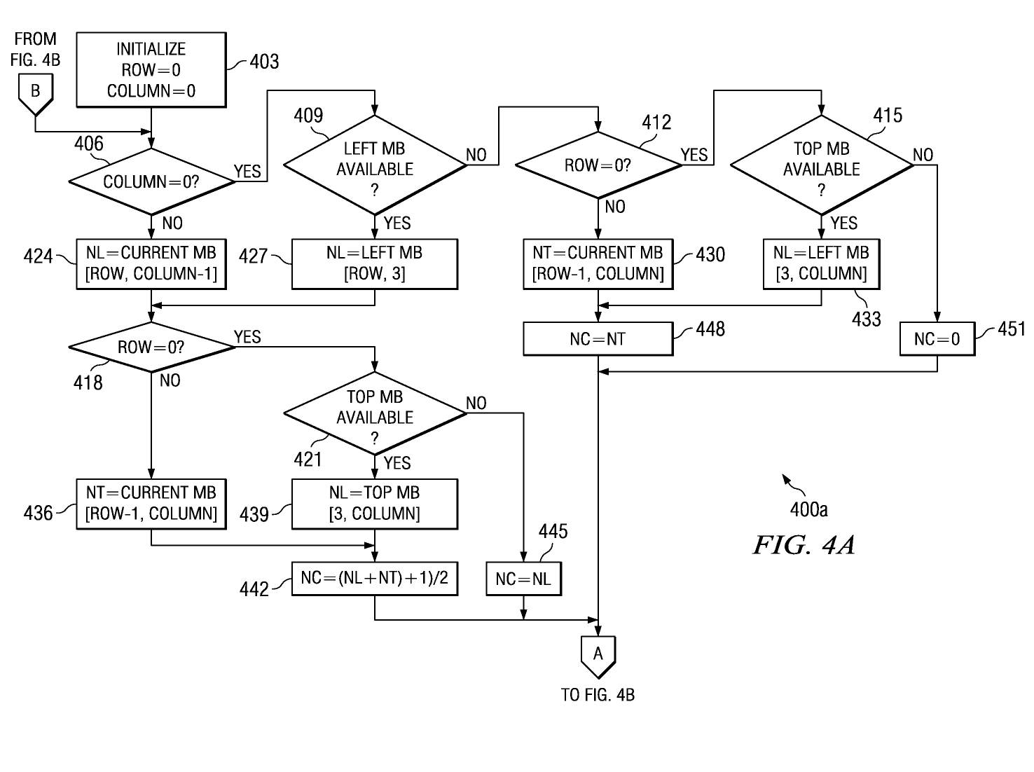

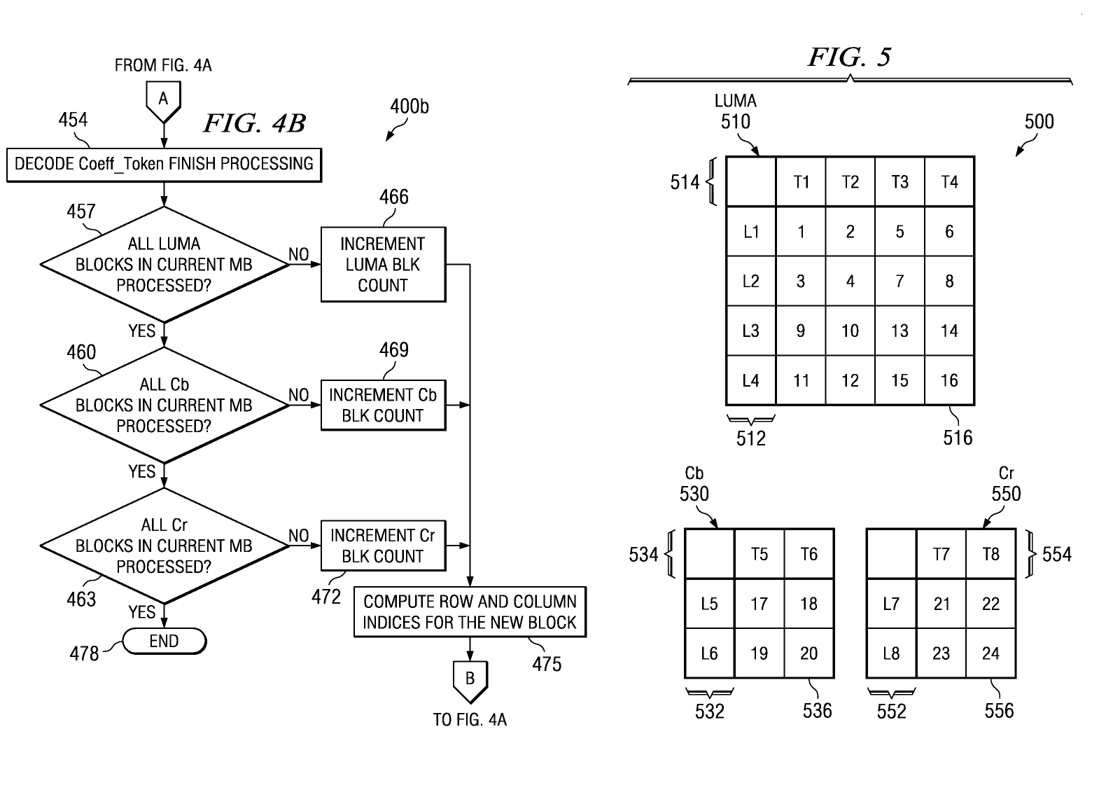

Turning now to FIG. 4a, a flow diagram 400 shows one method for determining neighboring block availability, and for calculating N_{C} before the start of the CAVLD decoding process. Following flow diagram 400, a row counter (i.e., Row) and a column counter (i.e., Column) are both initialized to zero (block 403). The Row and Column counters are used in combination to identify a particular location within a macro block. The upper left corner of a macro block has a Row value and a Column value equal to zero. In contrast, the lower right corner has a Row value and a Column value equal to three. The Row and Column counts are incremented as partitions within the current macro block are processed.

It is first determined whether the Column counter is equal to zero (block 406). In such a situation, N_{L} for the block being processed is in a left-hand macro block (i.e., Left MB). Thus, where the Column counter is not equal to zero (block 406), the neighboring N_{L} block for the block being processed is within the current macro block (i.e., Current MB) (block 424). Alternatively, where the Column counter is equal to zero (block 406), the neighboring N_{L} block for the block being processed is found in Left MB (block 427) where Left MB is available (block 409).

Where a value was assigned for N_{L} (blocks 424, 427), it is determined whether the Row counter is equal to zero (block 418). Where the Row counter is not equal to zero (block 418), the neighboring N_{T} block for the block being processed is within the Current MB (block 436). Alternatively, where the Row counter is equal to zero (block 418), the neighboring N_{T} block for the block being processed is found in upper macro block (i.e., Top MB) (block 439) where Top MB is available (block 421). In either of the aforementioned cases (blocks 436, 439) a value is assigned to both N_{L} and N_{T}, and thus the value of N_{C} is described by the following equation: N_{C}=(N_{L}+N_{T}+1)/2 (block 442). Alternatively, where Top MB is not available (block 421), no value is assigned for N_{T}, and the value assigned to N_{C} is described by the following equation: N_{C}=N_{L} (block 445).

Where the Column counter is equal to zero (block 406) and the Left MB is not available (block 409), no value is assigned to N_{L}. It is additionally determined whether the Row counter is equal to zero (block 412). Where the Row counter is not equal to zero (block 412), the neighboring N_{T} block for the block being processed is within the Current MB (block 430). Alternatively, where the Row counter is equal to zero (block 412), the neighboring N_{T} block for the block being processed is found in the Top MB (block 433) where Top MB is available (block 415). In either of the aforementioned cases (blocks 430, 436) a value is assigned to N_{T} but not N_{L}, and thus the value of N_{C} is described by the following equation: N_{C}=N_{T} (block 448). Alternatively, where Top MB is not available (block 415), no value is assigned to either N_{L} or N_{T} and the value assigned to N_{C} is zero (block 451).

With the value of N_{C} thus calculated, N_{C} may be used to decode the Coeff_Token and finish the CAVLD process for the given block as is known in the art (block 454). In general, the remaining processing is the reverse processes of those described below in relation to blocks 220-250 of FIG. 2. Once the processing is completed (block 454), the Coeff_Token decode process (blocks 406-454) is repeated for each of the other blocks in the Current MB by incrementing the Row and Column counters once all luma, Cb and Cr blocks of the current MB are processed (blocks 457-475). Once the last block in Current MB is processed, the Coeff_Token decode process is completed (block 478).

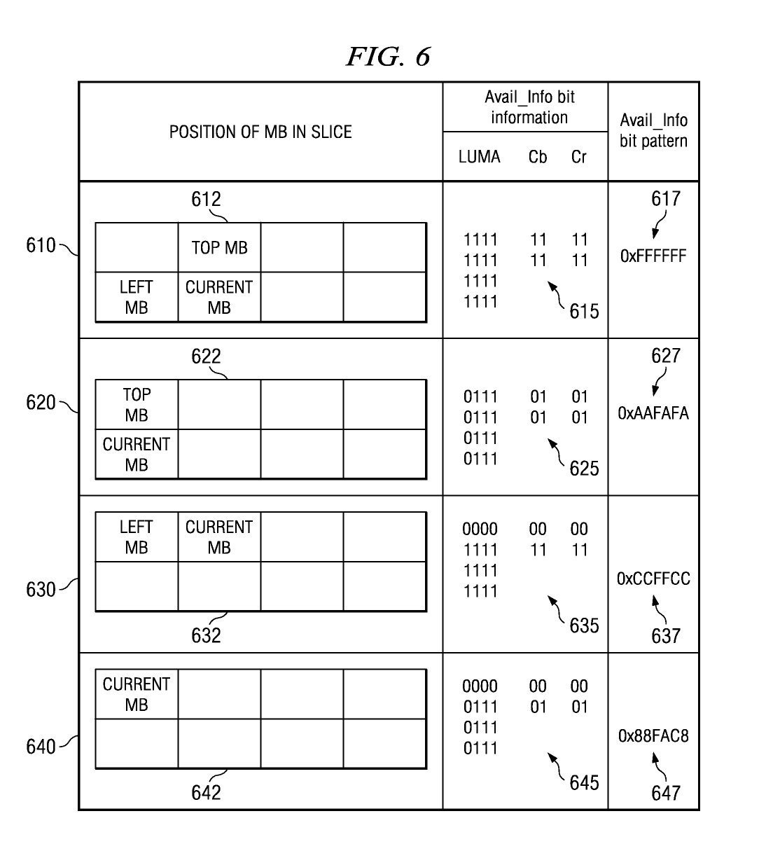

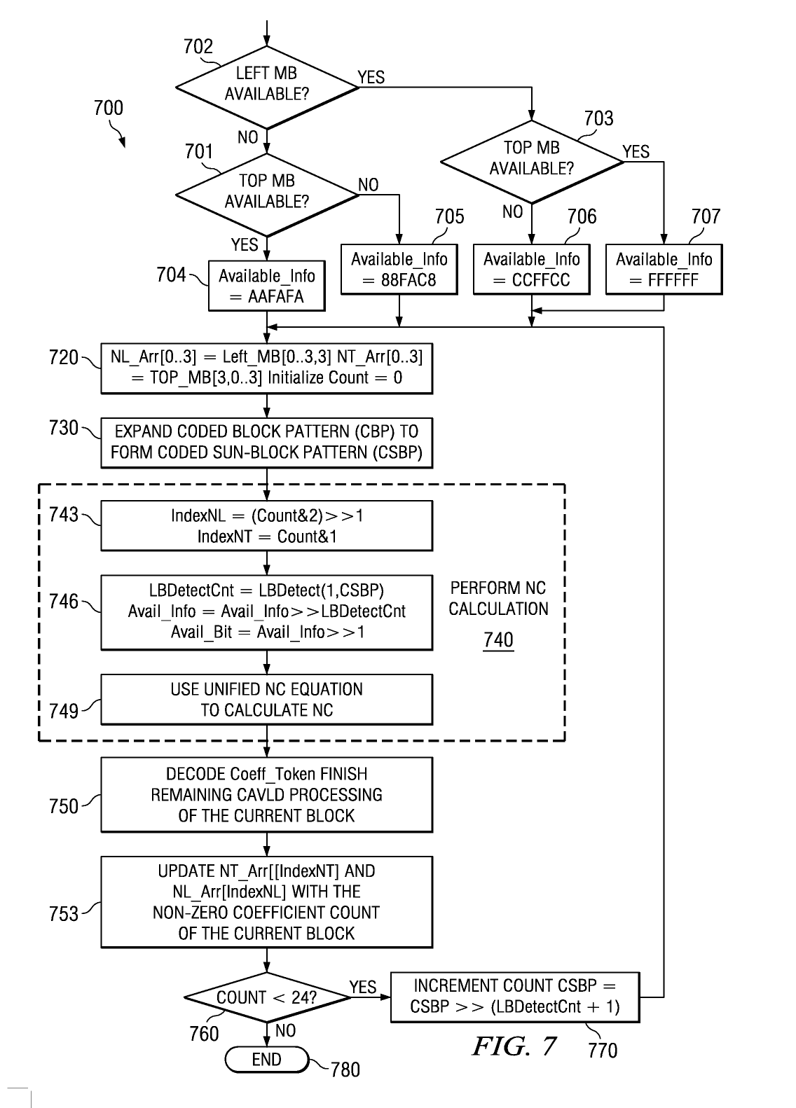

The process shown in flow diagram 400 demands considerable processing bandwidth (approximately three hundred cycles for each macro block processed), as well as memory to store the corresponding co-ordinates associated with each block. In contrast, one or more embodiments of the present invention implement a bit pattern based method for determining N_{C}. An example of such embodiments is more fully described in relation to FIGS. 6 through 7 below. Depending upon the processor chosen, such a bit pattern based approach can result in a dramatic reduction in processing bandwidth and/or memory demands associated with the calculation of N_{C}. As one of many examples, using a Texas Instruments TM320C64x DSP architecture, processing a macro block requires execution of about eight instructions and approximately twelve DSP cycles.

A twenty-four bit pattern (i.e., Avail_Info) is defined for each block depending upon the position of the macro block within a given slice. FIG. 6 depicts four alignments 610, 620, 630, 640 that are associated with the four possible twenty-four bit words used to represent available block information. In particular, alignment 610 includes the current MB at least one column from the far left of a slice 612, and at least one row from the top of slice 612. In this case, all predictors L1-L8 and T1-T8 are available for the current MB. This is depicted in a region 615 where a ‘1’ is placed in each position representing the availability of the twenty-four blocks corresponding to those described in FIG. 5. This results in an Avail_Info bit pattern 617 of 0xFFFFFF. To obtain Avail_Info bit pattern 617, the bits are assembled descending order from bit twenty-four to bit one.

Alignment 620 includes the current MB at least one row from the top of a slice 622, and at the far left column of slice 622. In this case, the far left column of predictors L1-L8 are not available, but all T1-T8 are available for the current MB. This is depicted in a region 625 where a ‘1’ is placed in each position representing an available predictor, and a ‘0’ indicates unavailable predictors for the twenty-four blocks corresponding to those described in FIG. 5. This results in an Avail_Info bit pattern 627 of 0xAAFAFA. Again, to obtain Avail_Info bit pattern 627, the bits are assembled descending order from bit twenty-four to bit one.

Alignment 630 includes the current MB at least one column from the far left of a slice 632, and at the top of slice 632. In this case, the top row of predictors T1-T8 are not available, but all L1-L8 are available for the current MB. This is depicted in a region 635 where a ‘1’ is placed in each position representing an available predictor, and a ‘0’ indicates unavailable predictors for the twenty-four blocks corresponding to those described in FIG. 5. This results in an Avail_Info bit pattern 637 of 0xCCFFCC. Again, to obtain Avail_Info bit pattern 637, the bits are assembled descending order from bit twenty-four to bit one.

Alignment 640 includes the current MB at the far left and top of a slice 642. In this case, neither of predictors T1-T8 nor L1-L8 are available for the current MB. This is depicted in a region 645 where a ‘1’ is placed in each position representing an available predictor, and a ‘0’ indicates unavailable predictors for the twenty-four blocks corresponding to those described in FIG. 5. This results in an Avail_Info bit pattern 647 of 0x88FAC8. Again, to obtain Avail_Info bit pattern 647, the bits are assembled descending order from bit twenty-four to bit one.

Turning now to FIG. 7, the previously described Avail_Info bit patterns may be used for calculating N_{C}. FIG. 7 includes a flow diagram 700 that shows an exemplary calculation of N_{C} utilizing a bit pattern approach in accordance with one or more embodiments of the present invention. In some cases, separate N_{L} and N_{T} arrays are maintained for neighboring blocks. These arrays may be dynamically updated while each block is decoded. Following flow diagram 700, a process for determining Avail_Info bit pattern information is performed (block 710). This process is similar to that described in relation to FIGS. 5 and 6, and includes determining for a particular macro block (i.e., the current MB) whether there is a left MB available (block 702) and whether there is a top MB available (blocks 701, 703). Where both a left MB (block 702) and a top MB (block 703) are available, the Avail_Info bit pattern is set to 0xFFFFFF (block 707). Where a left MB is available (block 702) but a top MB is not available (block 703), the Avail_Info bit pattern is set to 0xCCFFCC (block 706). Where a left MB is not available (block 702) but a top MB is available (block 701), the Avail_Info bit pattern is set to 0xAAFAFA (block 704). Where a left MB is not available (block 702) and a top MB is not available (block 701), the Avail_Info bit pattern is set to 0x88FAC8 (block 705).

NL_Arr and NT_Arr are updated using the respective left and top indices with the non-zero coefficient value decoded for the current block (block 720). This is done before starting the process of CAVLD including the Coeff_Token decoding for the subsequent block. Separate NL_Arr and NT_Arr are maintained for Cb and Cr. In particular, an array of left neighbors (i.e., NL_Arr[0..3]) is filled with the far right column of the available neighboring left MB and an array of top neighbors (i.e. NT_Arr[0..3]) is filled with the bottom row of the available top MB. For example, as illustrated in FIG. 3, where block R1, C1 of macro block 305 is being considered, NL_Arr[0..3] is loaded with the far right column of block R1, C4 of macro block 310, and N_{T} Arr[0..3] is loaded with the bottom row of block R4, C1 of macro block 315. As another example, where block R2, C2 of macro block 305 is being considered, NL_Arr[0..3] is loaded with the far right column of block R2, C1 of macro block 305, and NT_Arr[0..3] is loaded with the bottom row of block R1, C2 of macro block 305. Both of the arrays are loaded for each block under consideration. Where either of the top MB or the left MB is not available, the corresponding array is filled with zeros. This is described below in relation to block 740 where the N_{C} calculation is performed. A counter (i.e., Count) is also initialized to zero (block 720).

The coded block pattern (i.e., CBP) is expanded to form a coded sub-block pattern (i.e., CSBP) (block 730). Generating CSBP from CBP may be used in one or more embodiments of the present invention to provide memory savings and form an optimized reconstruction loop as more fully described in relation to block 740 below. In general, the CBP is provided for each 8×8 block indicating whether the 8×8 block includes any non-zero coefficients and thus has to be decoded. A CBP is assigned to each block and results in an irregular decode loop structure that often exhibits substantial overhead due to abrupt branching. In addition, general approaches to CBP coding allocate memory based on worst case scenarios where all blocks for a given macro block are assumed to be coded with non-zero coefficients.

The CBP is a six bit pattern that is available from the bitstream. In particular, the CBP is a six bit pattern with four least significant bits (i.e., right bits) assigned to Luma and the two most significant bits (i.e., left bits) assigned to chroma. Of the two chroma bits, the farthest left is a DC value and the other is an AC value. Where the DC value is equal to a ‘0’, the AC value will also be equal to ‘0’. Thus, possible chroma bit values (uvDC, uvAC) include: 11, 10, 00. The standard six bit CBP is expanded to a twenty-four bit CSBP. The CSBP is used to indicate blocks for which an N_{C} value is to be calculated. By providing this information, a non-branching direct index and calculation of an address for coded blocks is possible. Further, as more fully described below, the CSBP provides for efficient memory utilization by marking the zero-coefficient blocks, and only allocating memory for use in relation to the non-zero coefficient blocks. Thus, reconstruction loops make use of the CSBP and perform inverse transform and error addition only on the blocks with non-zero coefficients.

Expanding the CBP to obtain the CSBP begins by setting four consecutive bits of the CSBP equal to each bit of the CBP. This provides for the initial expansion from six bits to twenty four bits. This process is completed as the CBP is accessed from the bit stream. As a further refinement, where any of the chroma AC coefficients are present, it is assumed that the chroma DC component is also present and an inverse chroma hadamard is mandated. This same approach is used where only chroma DC coefficients are present because memory allocation is performed based on CSBP. Table 1 below shows four exemplary initial expansions from CBP to CSBP in accordance with the aforementioned rules.

TABLE 1
Exemplary Cases Demonstrating Initial Expansion from CBP to CSBP

| CBP | | | CSBP | | |
|---|---|---|---|---|---|
| uvDC | uvAC | Luma | Luma | Cb | Cr |
| 1 | 1 | 0001 | 0000000000001111 | 1111 | 1111 |
| 1 | 1 | 0010 | 0000000011110000 | 1111 | 1111 |
| 1 | 0 | 0100 | 0000111100000000 | 1111 | 1111 |
| 0 | 0 | 1000 | 1111000000000000 | 0000 | 0000 |

It should be noted that the CBP can include most combinations of six-bits, and that combination of six bits is initially expanded in accordance with the rules set forth above. The initially expanded CSBP is read from left to right. Where a zero is encountered in reading the CSBP, the corresponding block of the macro block is skipped during the decoding process. As a zero in the CBP is expanded to form four consecutive zeros in the CSBP, each zero in the CSBP will be encountered in a group of four zeros. As one example, where CBP is equal to six or ‘000110’, the last four blocks of Luma are marked as not to be decoded. Further, these blocks as well as all other blocks that contain all zero coefficients are not stored in memory. As will be appreciated from the disclosure provided above, an N_{C} calculation is not needed for blocks that are marked as zero.

Based on the preceding information, the N_{C} calculation is performed (block 740). The N_{C} calculation involves initializing an index for the left neighbor (i.e., IndexNL) and an index for the top neighbor (i.e., IndexNT) (block 743). These indexes are derived from a counter (i.e, Count) that is used to control processing location within the macro block. In particular, IndexNL and IndexNT are derived as follows based on the counter that varies between 0 and 23 and includes at least four least significant bits (i.e., bit3, bit2, bit1, bit0). Luma blocks are indicated by a count between 0 and 15, and Croma blocks are indicated by a count between 16 and 23. For Luma blocks, Index N_{L} equals (bit3, bit1) and Index N_{T} equals (bit2, bit0). For Chroma blocks, Index N_{L} equals bit1 and Index N_{T} equals bit0. Thus, for example, when Count equals 13 (binary representation of ‘1101’), Index N_{L} equals ‘10’ and Index N_{T} equals ‘11’ (each represented in binary). This extraction of bits to get Index N_{L} and Index N_{T} from the counter can be performed efficiently using instructions available in typical digital signal processor.

Table 2 below shows the various values of IndexNL and IndexNT for the blocks shown in FIG. 5.

TABLE 2
Index Values for Respective Blocks as Shown in FIG. 5

| | Count + 1 | | | |
|---|---|---|---|---|
| | 1, 2, 5, 6, 17, | 3, 4, 7, 8, | | 11, 12, 15, |
| | 18, 21, 22 | 19, 20, 23, 24 | 9, 10, 13, 14 | 16 |
| IndexNL | 0 | ‘1’ (binary) | ‘10’ (binary) | ‘11’ (binary) |
| | Count + 1 | | | |
| | 1, 3, 9, 11, 17, | 2, 4, 10, 12, | | |
| | 19, 21, 23 | 18, 20, 22, 24 | 5, 7, 13, 15 | 6, 8, 14, 16 |
| IndexNT | 0 | ‘1’ (binary) | ‘10’ (binary) | ‘11’ (binary) |

A function, LBDetect(1, CSBP), is called that returns a count of how many contiguous zero coefficients are recorded in the left most portion of the CSBP data. In other words, LBDetect detects the first occurrence of a ‘1’ from the left most side of the CSBP. This number is recorded as LBDetectCnt. Avail_Info is then updated by shifting to the left by an amount equal to the number of contiguous zeros, LBDetectCnt. Thus, Avail_Info is shifted to the left such that the least significant bit (i.e., the farthest right bit) corresponds to the next block with a potentially non-zero coefficient that is marked as a ‘1’ in the CSBP. Avail_Info is then masked with a ‘1’ and that value is stored as Avail_Bit which will have a value of either one or zero depending upon the masked bit. As will be appreciated from reading the aforementioned approach, blocks that are marked as ‘0’ in the CSBP are skipped without using a branch based algorithm. This, avoids calculation of N_{C} for such blocks, and makes the algorithm more suited for a parallel implementation.

Using this information, a parallel tailored N_{C} equation can be used to calculate N_{C} (block 749). This parallel equation eliminates the branching associated with the N_{C} calculation described in relation to FIG. 4 above, and thus makes decoding more practical for parallel implementations, such as that of a VLIW processor. The parallel tailored N_{C} calculation is as follows:

N_{C}=(NL_{—}Arr[IndexNL]+NT_{—}Arr[IndexNT]+Avail_Bit)>>Avail_Bit

A couple of concrete examples are now provided to demonstrate the previously discussed algorithm. First, the condition where both the N_{L} and N_{T} are available is considered. In such a ease, NL_Arr[0..3] and N_{T} Arr[0..3] have been filled with the appropriate non-zero information from the neighboring blocks and Avail_Bit is equal to one. Further, assume that the luma block under consideration is 14 (i.e, Count=13) as shown in FIG. 5 yielding an IndexNL of ‘2’ and an IndexNT of ‘3’ (represented in decimal). Thus, the aforementioned parallel tailored N_{C} equation reduces to:

N_{C}=(NL_{—}Arr[2]+NT_{—}Arr[3]+1)>>1.

This equation is equivalent to the standard N_{C} equation where both N_{L} and N_{T} are available as described above. As another example, assume N_{L} is available and N_{T} is not available. In such a case, NL_Arr[0..3] has been filled with the appropriate non-zero information from the neighboring block and NT_Arr[0..3]=‘0000’, and Avail_Bit is equal to zero. Further, assume that the luma block under consideration is 1 (i.e., Count=0) as shown in FIG. 5 yielding an IndexNL of ‘0’ and an IndexNT of ‘0’. Thus, the aforementioned parallel tailored N_{C} equation reduces to:

N_{C}=NL_Arr[0]

Again, this is equivalent to the standard N_{C} equation where N_{L} is available, and N_{T} is not available as described above. Similarly, where we assume N_{T} is available and N_{L} is not available and all other conditions remain the same, the aforementioned parallel tailored N_{C} equation reduces to:

N_{C}=NT_Arr[0]

Again, this is equivalent to the standard N_{C} equation where N_{T} is available, and N_{L} is not available as described above. Similarly, where assume neither N_{T} nor N_{L} are available and all other conditions remain the same, the aforementioned parallel tailored N_{C} equation reduces to:

N_{C}=0

### Again, this is equivalent to the standard N_{C} equation where neither N_{T} nor N_{L} are available as described above.

The calculated N_{C} value is then used to decode the Coeff_Token and processing is completed for the current block (block 750). In particular, after calculating N_{C}, it can be used to select the appropriate look-up table (from one of four look-up tables as per specification in H.264 standard) as set forth in Table 3 below.

TABLE 3
Look-Up Table Selection

| N_{C} | Table for Coeff Token |
|---|---|
| 0–1 | Table #1 |
| 2–3 | Table #2 |
| 4–7 | Table #3 |
| >7 | Table #4 |

Further, in some embodiments of the present invention, the CSBP is further refined based on information achieved during the decoding process. In particular, where the decoded Coeff_Token indicates that the decoded block has at least one non-zero coefficient, the bit in the CSBP corresponding to the decoded block is left as a ‘1’. Alternatively, where the decoded Coeff_Token indicates that the decoded block does not have any non-zero coefficients, the bit in the CSBP corresponding to the decoded block is changed to a zero. Thus, a zero in the CSBP avoids wasting processing time decoding blocks that are known to be all zeros as they are marked with zeros. Further, a sub-block that is found to have all zero coefficients is marked as such precluding any further decoding on the sub-block. In some embodiments of the present invention, this refined CSBP can be used to increase memory utilization related to the storage of decoded coefficients. In particular, a loop responsible for reconstructing the original block may make use of the refined CSBP to limit performance of an inverse transform and/or error addition to only blocks with non-zero coefficients. Further, there is no need to allocate memory to a block that does not include non-zero coefficients.

In some embodiments of the present invention, the memory area saved by not allocating memory for blocks that do not have any non-zero coefficients is utilized for storing predictor blocks from reference regions. The unused memory space may be designated as a reference region that is grown from the opposite end as the coefficient region. This approach dynamically and optimally allocates memory for a variable number of macro blocks within a fixed memory space.

After processing of block 750 is complete, the NT_Arr and NL_Arr are updated with the non-zero coefficient count of the current block (block 753). The aforementioned process (blocks 740 through 753) is repeated for each block within Current MB. This includes determining whether the counter has incremented to twenty-four (block 760). Where Count is less than twenty-four (block 760), Count is incremented, and the coded sub-block pattern is shifted to the right by an amount equal to the LBDetectCnt plus one (block 770). After this, the processes of blocks 740 through 753 are repeated. Alternatively, where the count has increased to twenty-four, the process is completed (block 780).

Returning to FIG. 2, after the Coeff_Token is encoded, the sign for each of the T1s is encoded (block 220). The signs are encoded in reverse order with the higher frequency values encoded first and followed by the progressively lower frequency T1s. The sign is encoded using a single bit encoding where ‘0’ indicates a positive sign, and ‘1’ indicates a negative sign. Decoding the signs of the T1s involves reversing the order of the encode process.

The level (i.e., sign and magnitude) of each of the remaining non-zero coefficients in the block is encoded in reverse order starting with the highest frequency coefficient and working backward to the DC coefficient (block 230). Another set of look-up tables is used to encode the levels depending on the magnitude of each successive coded level. There are seven level look-up tables that can be accessed: Level0 to Level6. The choice of look-up table is adapted by first initializing the table selection to Level0, unless there are more than ten non-zero coefficients and less three T1s where the table selection is initialized to Level1. Next, the highest frequency non-zero coefficient is encoded. Where the magnitude of the preceding non-zero coefficient is larger than a defined threshold, the level is incremented (e.g., from Level0 to Level1). The following Table 4 shows some exemplary threshold levels associated with incrementing the table selection:

TABLE 4
Level Increment Thresholds

| Current Table | Defined Threshold |
|---|---|
| Level0 | 0 |
| Level1 | 3 |
| Level2 | 6 |
| Level3 | 12 |
| Level4 | 24 |
| Level5 | 48 |
| Level6 | |

### Again, decoding the threshold levels involves reversing the encoding process.

Continuing with flow diagram 200, the total number of zeros before the last non-zero coefficient are encoded (block 240). The total number of zeros is the sum of all zeros preceding the highest non-zero coefficient in the reordered block. This is encoded using look-up tables. Next, runs of zeros are encoded (block 250). The number of zeros preceding each non-zero coefficient is commonly referred to as a “run before”. The run before values are coded in reverse order from the high frequency coefficients to the DC coefficient. There are two notable exceptions in run before processing. First, where the number of zeros that remain for processing is zero, run before coding is stopped. Second, it is not necessary to encode the run before occurring before the lowest frequency non-zero coefficient. The look-up table used to encode run before values is chosen based on the number of zeros that have not yet been encoded, and the run before value.

The following example further illustrates the CAVLC encoding process where it is assumed that the value of Coeff_Token is 1, table Num0 is selected for encoding, and the following 4×4 partition is to be encoded:

| | | | |
|---|---|---|---|
| 7 | 0 | 0 | 0 |
| 0 | 0 | 8 | 0 |
| −2 | 0 | 1 | 0 |
| −1 | 0 | 0 | 0 |

The 4×4 partition is reordered using the aforementioned zigzag pattern from lower frequency coefficients to higher frequency coefficients to yield the following one dimensional array:

| | | | | | | | | | | | | | | | |
|---|---|---|---|---|---|---|---|---|---|---|---|---|---|---|---|
| 7 | 0 | 0 | −2 | 0 | 0 | 0 | 8 | 0 | −1 | 0 | 1 | 0 | 0 | 0 | 0 |

In this case, the number of T1s is two, the number of non-zero coefficients is five, and the total zeros is seven. This information is used to encode Coeff_Token from a table available in the previously mentioned H.264 specification. For purposes of this discussion, we will assume that the encoded Coeff_Token from the table is ‘[COEFF]’. Next, the T1s are encoded from the highest frequency to the lowest frequency. Thus, the code representing the two T1s is ‘[01]’. Next, level decoding is performed using the tables from the H.264 specification for the three levels that are to be represented. For the purposes of this discussion it is assumed that the following encoded level information is provided from the tables ‘[LEVEL(8)], [LEVEL(−2)], [LEVEL(7)]’. Next, the total number of zeros is encoded using a look-up table from the H.264 specification. For the purposes of this discussion, it is assumed that the total number of zeros is encoded to be ‘TOTAL ZEROS’. There are also a total of four run before values that are to be encoded. For the purposes of this description, the four run before values are encoded as follows: ‘[ZEROS LEFT 7, RUN BEFORE 1]; [ZEROS LEFT 6, RUN BEFORE 1]; [ZEROS LEFT 5, RUN BEFORE 3]; [ZEROS LEFT 2, RUN BEFORE 2]’. Thus, the following encoded bit stream is transmitted:

[COEFF], [01], [LEVEL(8)], [LEVEL(−2)], [LEVEL(7)], [TOTAL
ZEROS] [ZEROS LEFT 7, RUN BEFORE 1], [ZEROS LEFT 6,
RUN BEFORE 1], [ZEROS LEFT 5, RUN BEFORE 3],
[ZEROS LEFT 2, RUN BEFORE 2]

As will be appreciated by one of ordinary skill in the art based on the preceding disclosure, in encoding run before value, there is a dependency on the previous run before value since table selection is a function of zeros left at a given point. Similarly, in decoding run before information, the appropriate look-up table is selected depending on the zeros left at a given point in time. Thus, decoding successive run before values involves a data dependency where the number of zeros left is updated only after completion of the preceding run before. The aforementioned data dependency inherently limits parallelism and reduces the effectiveness of a VLIW architecture. Such a conventional decoding mechanism is illustrated using the following simplified pseudo code provided in Table 5 below:

TABLE 5
Pseudo-Code Illustrating Data Dependent Run Before Decoding

(A) WHILE (ZerosLeft > 0 AND CoefLeft > 0)
{

| | |
|---|---|
| (B) | run_before_data = RunBeforeTable[zerosLeft*TBLSIZE + |
| | BitStreamWord>>29]; |
| (C) | run before value = run_before_data & 0xF; |
| | BitFlushCnt = run_before_data >> 4; |
| (D) | ZerosLeft = ZerosLeft − run before value; |
| | CoefPosition = CoefPosition − run before value; |

}

Following the pseudo-code in Table 3, at part (A) a loop statement indicates that the loop will be repeated as long as there are both some zeros and some coefficients left in the encoded bit stream. Before the loop begins, the zeros left is initialized to the total number of zeros, and the coefficient position is initialized. It should be noted that the pseudocode assumes that there are a maximum of six zeros left, and hence only three bits are read from the encoded bit stream. In the rare case where there are more than six zeros left, it may be handled in a separate decoding function. For each pass through the loop controlled by part (A), parts (B), (C), and (D) are performed. In part (B), run before data is extracted from the run before look up tables using information from the incoming encoded bit stream. The run before look up tables (i.e., RunBeforeTable) is comprised of a number of sub-tables of size TABLESIZE that each correspond to a particular number of zeros left to be decoded. Extracting the run before data includes creating a table index which is the number of zeros left multiplied by TABLESIZE, plus an offset into the sub-table. The offset is found in the three most significant bits of a thirty-two bit word (BitStreamWord) read from the encoded bit stream. Again, this offset is used for lookup into the table. To get these bits, the BitStreamWord is shifted right by twenty-nine bits.

In part (C), the run before value is masked out of the run before data retrieved from the look up table. The run before data contains packed information containing run before value and number of bits to flush. The number of bits allocated to each of the fields will depend on the design of the look-up table. For example, we use four bits each to represent run before value and number of bits to flush. As we pack the run before value in the four least significant bits of the run before data, a four bit mask, 0xF, is used. In addition, the number of bits to flush, BitFlushCnt, out of the received encoded bit stream is accessed by shifting the run before data to the right by four bits. In part (D), the number of zeros left to be decoded and the coefficient position are updated by subtracting from each the run before value.

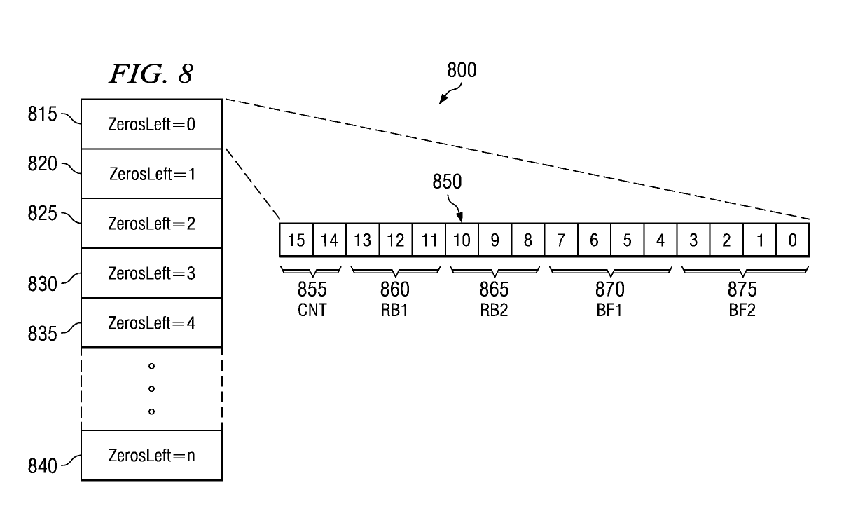

Some embodiments of the present invention provide a novel approach for decoding run before values such that data dependencies are reduced, and a corresponding increase in parallelism is achieved. Such embodiments provide for decoding two or more run before values in a single table look-up using a modified run before table. For purposes of discussion, the approach is described where two run before values are simultaneously accessed using a modified run before table structure as depicted in FIG. 8. In particular, a run before table structure 800 is shown that includes a number of sub-tables 815, 820, 825, 830, 835, 840 each associated with a particular value of ZerosLeft. Each of sub-tables 815, 820, 825, 830, 835, 840 includes 2^{N} entries where ‘N’ is the number of bits of the bit stream that are used for the table look-up. Each entry within the respective sub-tables includes sixteen bits, and can be used to decode two run before values. An exemplary sixteen bit entry 850 is shown with its respective elements: CNT 855, RB1 860, RB2 865, BF1 870, BF2 875. CNT 855 is the number of valid run before values to be decoded (valid values are one and two). RB1 860 and RB2 865 are the consecutive run before values for the respective, concurrent run before look-ups. RB2 865 is only valid when CNT 855 is equal to two. BF1 870 and BF2 875 represent the cumulative bits to flush up-to the particular given run before decode. It should be noted that when CNT 850 is equal to one, BF2 875 is equal to BF1 870.

Run before table structure 800 includes a fixed number of bits (i.e., ‘N’) that are read from the bit stream from which either one or two run before values are decoded. The first run before value, RB1, is always valid and is a function of ZerosLeft used in selecting an appropriate sub-table 815, 820, 825, 830, 835, 380. In contrast, the value of ZerosLeft for RB2 is immediately calculated using the equation ZerosLeft=ZerosLeft−RB1. This value can be calculated before a table look-up involving the RB1 data is completed, and thus can be concurrently used as an index into Run before table structure 300 to access the run before value associated with RB2. This reduction in data dependency offers a corresponding increase in parallelism. Whether RB2 is valid is determined by the total number of bits required to decode the combination of RB1 and RB2. If the number of bits required to decode is greater than ‘N’, then only RB1 is valid and CNT should be set to one. It may be possible that a particular table has a valid value for RB2, but that it is not utilized for a look-up because there are no coefficients left before the RB1 decode.

Table 6 below provides pseudo-code representing an exemplary run before decode utilizing run before table structure 800 in accordance with some embodiments of the present invention where ‘N’ equals eight.

TABLE 6
Pseudo-Code Illustrating Multiple Concurrent Run before Decoding

(A) WHILE (CoefLeft>0)
{

| | |
|---|---|
| (B) | run before_data = RunBeforeTable [ZerosLeft*RBSIZE + |
| | BitStreamWord >>24] |
| (C) | RB1 = (run before_data & 0x3800) >> 11; |
| | RB2 = (run before_data & 0x700) >> 8; |
| | BF1 = (run before_data & 0xF0) >> 4; |
| | BF2 = run before_data & 0xF; |
| | CNT = (run before_data & 0xC000) >> 14; |
| (D) | bits2flush = BF1; |
| | ZerosLeft −= RB1; |
| | CoefLeft−−; |

```
  (E) if ( (CoefLeft>1)&&(CNT==2) )
  {
```

| | |
|---|---|
| (F) | bits2flush = BF2; |
| | ZerosLeft = ZerosLeft − RB2; |
| | CoefLeft−−; |

```
  }
  // update bitstream with bits2flush
}
```

Following the pseudo-code in Table 4, at part (A) a loop statement indicates that the loop will be repeated as long as there is at least one coefficient remains to be decoded from the encoded bit stream. Similar to that of Table 3, it should be noted that the pseudocode assumes that there are a maximum of six zeros left, and hence only three bits are read from the encoded bit stream. In the rare case where there are more than six zeros left, it may be handled in a separate decoding function. Before the loop begins, the zeros left is initialized to the total number of zeros, and the coefficient position is initialized. For each pass through the loop controlled by part (A), parts (B), (C), (D), (E) and (F) are performed. In part (B), run before data is extracted from the run before look up tables using information from the incoming encoded bit stream. The run before look up tables (i.e., RunBeforeTable) is comprised of a number of sub-tables of size RBSIZE that each correspond to a particular number of zeros left to be decoded. Extracting the run before data includes creating a table index which is the number of zeros left multiplied by RBSIZE, plus an offset into the sub-table. The offset is found in the eight most significant bits of a thirty-two bit word (BitStreamWord) read from the encoded bit stream. To get these bits, the BitStreamWord is shifted right by twenty-four bits.

In part (C), the two run before values, the two bits to flush values, and the CNT value is masked out of the run before data retrieved from the look up table. The masking is as shown in the pseudo-code and serves to extract the relevant data as depicted in FIG. 8. In part (D), the number of zeros left to be decoded and the bits to flush from the encoded bit stream are determined by subtracting from each the run before value. In addition, the number of coefficients left is decremented.

At part (E) a conditional statement indicates that the loop will be repeated as long as there is at least one coefficient remains to be decoded and that the CNT value indicates that two run before values were included in the run before data retrieved from the memory access of part (B). Where such is the case, the second run before value is accepted, and the various pointers are updated. In particular, in part (F), the bits to flush value is set equal to BF2, the number of zeros left is decremented by the second run before value, and the number of coefficients left is decremented.

Using the preceding approach, up to two run before values are decoded in a single iteration using the aforementioned approach. This leads to better parallelization and software pipelining. In some cases, the parallelization leads to an approximate doubling in performance compared with the single run before decode. Again, it should be noted that the aforementioned approach could be expanded to allow for decoding of three or more run before values for each memory access. This would require additional memory allocation for the run before table to hold the additional run before values, bit flush values, and count bits.

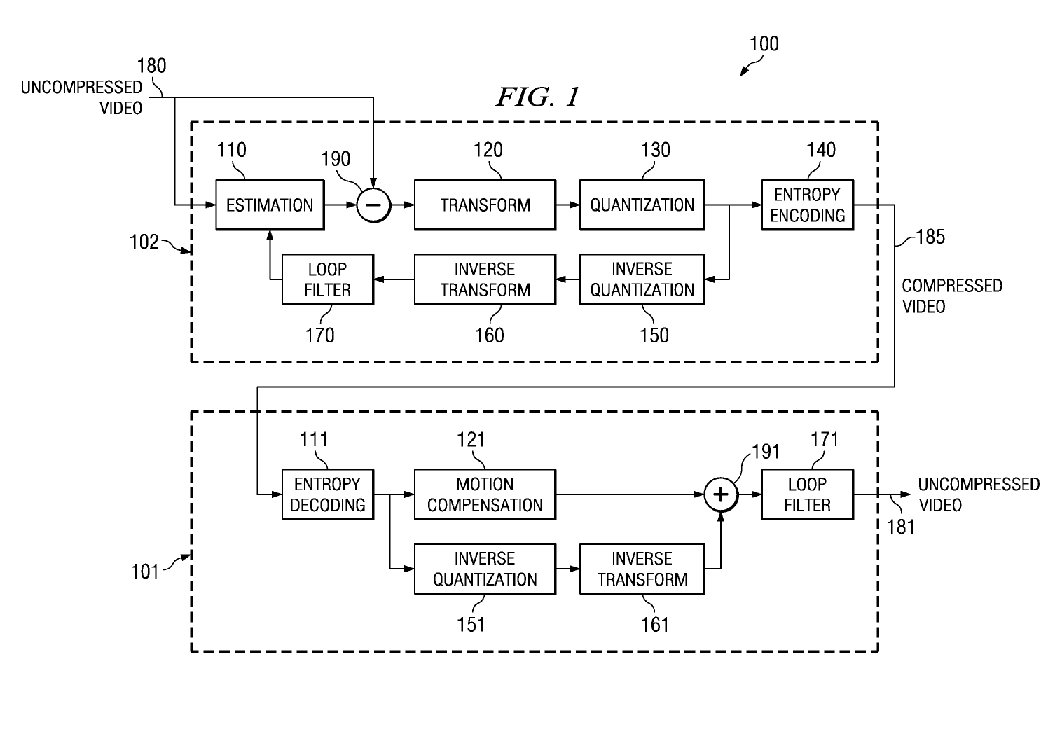

In standard processing, quantization is performed on the encoder side before entropy encoding as shown by quantization block 130 and entropy encoding block 140 of FIG. 1. On the decoder side, inverse quantization is performed after entropy decoding to effectively reverse the processes performed on the encoder side. Such an inverse quantization is typically done in a loop separate from the processing of the run before values. This approach requires loading various coefficients that were created during the previously discussed CAVLD process. Inverse quantization is performed on these coefficients and the inverse quantized values are stored back to their respective memory positions. Using such a process, it is not possible to determine before processing which of the coefficients have non-zero values. Thus, if the approach is implemented, inverse quantization is performed on each coefficient including those with zero value.

Some embodiments of the present invention provide for integrating run before value processing with inverse quantization. Such an approach avoids the aforementioned memory loads. This is appropriate where the levels are coded separately from the run before values, and the position of the levels cannot be determined within the level decoding loop. However, some embodiments of the present invention do provide for integrating run before decoding that is integrated with inverse quantization. Such integration approaches avoid inverse quantizing zero coefficients, and extra clock cycles that are wasted loading coefficient values. It should be noted that the refined CSBP indicates to a fine level which blocks do not include any non-zero coefficients. Thus, the refined CSBP may be incorporated into the inverse quantization process to avoid performing inverse quantization on blocks that do not include any non-zero coefficients.

In conclusion, the present invention provides novel systems, methods and arrangements for media production color management. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for decoding video image data, the method comprising:
receiving an encoded video image data set;
determining a run before value based on the encoded video image data set;
determining a non-zero coefficient value based on the encoded video image data set;
storing the non-zero coefficient value in a memory register;
determining a position of the non-zero coefficient value; and
performing an inverse quantization utilizing the non-zero coefficient value prior to removing the non-zero coefficient value from the memory register.

2. The method of claim 1, wherein the method precludes performing an inverse quantization on zero coefficients.

3. The method of claim 1, wherein performing the inverse quantization utilizing the non-zero coefficient includes accessing the non-zero coefficient from the memory register.

4. The method of claim 1, wherein performing the inverse quantization utilizing the non-zero coefficient is performed immediately subsequent to determining the position of the non-zero coefficient value.

5. The method of claim 1, wherein performing the inverse quantization utilizing the non-zero coefficient is performed prior to determining a subsequent non-zero coefficient value.

6. The method of claim 1, wherein determining the position of the non-zero coefficient value is based at least in part on the run before value.

7. A method for decoding video data, the method comprising:
providing a look up table memory, wherein the look up table memory is organized as a plurality of words, wherein each of the plurality of words is accessible via a single access to the look up table memory, and wherein a particular word of the plurality of words includes at least a first decoded run before value and a second decoded run before value.

8. The method of claim 7, wherein the method further comprises:
receiving an encoded video image data set;
extracting an encoded run before value from the encoded video image data set;
accessing the particular word from the look up table memory, wherein the particular word is indicated by the encoded run before value;
extracting the first run before value from the particular word; and
extracting the second run before value from the particular word.

9. The method of claim 8, wherein the particular word of the plurality of words further includes a third run before value, and wherein the method further includes:
extracting the third run before value from the particular word.

10. The method of claim 8, wherein the particular word includes an indicator, and wherein the indicator indicates that multiple valid run before values are included in the particular word.

11. A method for decoding an encoded video image data set, the method comprising:
assigning a neighbor block availability word to a block within the encoded video image data set;
loading an array of neighbor block information associated with the block within the encoded video image data set; and
calculating an N_{C} value associated with the block within the encoded video image data set, wherein a parallel tailored equation is used to perform the calculation, and wherein the variables of the parallel tailored equation include a derivative of the array of neighbor block information and a derivative of the neighbor block availability word.

12. The method of claim 11, wherein the method further comprises:
forming the neighbor block availability word, wherein the neighbor block availability word is formed based on a location of a block within the video image data set.

13. The method of claim 11, wherein the encoded video image data set is formed by groups of 16×16 pixels of luma data and groups of two blocks of 8×8 pixels representing chroma data.

14. The method of claim 13, wherein the neighbor block availability word is selected from a group consisting of: 0xFFFFFF; 0xAAFAFA; 0xCCFFCC; and 0x88FAC8.

15. The method of claim 11, wherein loading the array of neighbor block information includes loading a first array and a second array, wherein the first array is loaded with top neighbor information, and wherein the second array is loaded with left neighbor information.

16. The method of claim 15, wherein the parallel tailored equation includes a component from the first array and a component from the second array.

17. A method for reducing computational bandwidth associated with decoding an encoded video image data set, the method comprising:
accessing a coded block pattern, wherein the coded block pattern includes a plurality of indicators each representing N blocks, wherein N is a number greater than one, and wherein each of the indicators identifies an availability of non-zero coefficients; and
expanding the coded block pattern to form a coded sub-block pattern, wherein expanding the coded block pattern includes replicating each indicator of the coded block pattern N times such that each block is represented in the coded sub block pattern by one indicator.

18. The method of claim 17, wherein the method further includes:
decoding a block, wherein the decoded block is associated with an indicator in the coded sub-block pattern, and wherein the indicator indicates that at least one non-zero coefficient is available from the block;
determining that no non-zero coefficients are available from the block; and
modifying the indicator such that no non-zero coefficients are indicated.

19. The method of claim 18, wherein the method further includes:
performing an inverse quantization, wherein the inverse quantization includes:
accessing the indicator; and
based at least in part on the indicator, proceeding with an inverse quantization for the block.

20. The method of claim 19, wherein inverse quantization is performed only where the indicator indicates at least one non-zero coefficient.

21. The method of clam 17, wherein the coded block pattern includes six bits representing a 16×16 luma block and two blocks of 8×8 pixels representing chroma data is expanded to twenty-four bits of coded sub-block pattern, and wherein each bit of the coded sub-block pattern represents one 4×4 block.

22. The method of claim 21, wherein N equals four.
